(19) United States
(12) Patent Application Publication
(10) Pub. No.: US 2012/0199670 A1
(43) Pub. Date: Aug. 9, 2012

(54) REDUCED DRAG AFTERBURNER NOZZLE ACTUATION SYSTEM

(75) Inventors: Brian Jardine, Scottsdale, AZ (US); Peter Hall, Phoenix, AZ (US); Kevin Shepherd, Phoenix, AZ (US)

(73) Assignee: HONEYWELL INTERNATIONAL INC., Morristown, NJ (US)

(21) Appl. No.: 13/021,233

(22) Filed: Feb. 4, 2011

(51) Int. Cl. F02K 1/06; F02K 1/12

(52) U.S. Cl. 239/265.19

(57) ABSTRACT

An afterburner nozzle actuation system includes a case, an actuation structure, a plurality of cam plates, a plurality of nozzle flaps and seals, and a plurality of rollers. The actuation structure surrounds at least a portion of the case and includes an aft end that has a polygonal cross section shape. The cam plates are removably coupled to an inner surface of the actuation structure, and each includes a cam surface. The nozzle flaps are rotationally coupled to the case and extend at least partially from the actuation structure aft end. Each nozzle flap is movably coupled to a different one of the cam plates. The rollers are each rotationally mounted on a different one of the nozzle flaps and engage the cam surface of one of the cam plates.

### TECHNICAL FIELD

The technical field generally relates to afterburner nozzle actuation systems, and more particularly relates to an afterburner nozzle actuation system that is relatively small, exhibits low drag, reduced weight, reduced part count, reduced actuation loads, and provides improved maintainability.

### BACKGROUND

Some aircraft gas turbine propulsion engines are equipped with an afterburner. An afterburner may be used to provide increased thrust for supersonic flight, for takeoff and, in the case of military aircraft, for combat situations. No matter the reason for its specific use, an afterburner in an aircraft gas turbine propulsion engine is typically activated only after the propulsion turbine has reached its maximum speed and thrust. This is because afterburner fuel efficiency is usually relatively poor as compared to the main engine.

An afterburner (or reheat) is typically disposed downstream of the turbine, and includes a plurality of fuel injectors and a variable geometry exhaust nozzle. The afterburner provides increased thrust by injecting fuel, via the fuel injectors, into the exhaust section of the engine downstream of the turbine. The variable geometry exhaust nozzle, via an afterburner nozzle actuation system, varies the flow area of the downstream flow path using flaps and seals.

Variable geometry exhaust nozzles are often exposed to external flow and may, in some instances, need to fit into a desired size envelope. The size and shape of the structure that interacts with the nozzle flaps and seals can impose limits on the aerodynamic design of the exterior surfaces and/or exceed the desired size envelope. In order to minimize the limits imposed on the aerodynamic design and ensure that the desired size envelope is not exceeded, the actuation structure should achieve a minimal outer diameter. Additionally, reduced weight, part count and actuation loads, as well as improved maintainability and configurability are desirable.

Accordingly, it is desirable to provide an actuation structure for an afterburner nozzle actuation system that has a relatively small outer diameter. Additionally, it is desirable to provide an afterburner nozzle actuation system that exhibits reduced weight, part count, and actuation loads, as well as improved maintainability and configurability, relative to presently known systems.

### BRIEF SUMMARY

In one embodiment, an afterburner nozzle actuation system includes a case, an actuation structure, a plurality of cam plates, a plurality of nozzles, and a plurality of rollers. The case is adapted to mount to a gas turbine engine. The actuation structure surrounds at least a portion of the case and includes a forward end, an aft end, an inner surface, and an outer surface. The aft end has a polygonal cross section shape. The actuation structure is adapted to receive an actuation force from an afterburner nozzle actuator and is configured, upon receipt of the actuation force, to translate relative to the case in either an open direction or a closed direction. The cam plates are removably coupled to the inner surface of the actuation structure, and each includes a cam surface. The nozzle flaps are rotationally coupled to the case and extend at least partially from the actuation structure aft end. Each nozzle flap is movably coupled to a different one of the cam plates. The rollers are each rotationally mounted on a different one of the nozzle flaps and engage the cam surface of one of the cam plates.

In another embodiment, an afterburner nozzle actuation system includes a case, a plurality of afterburner actuation nozzles, an actuation structure, a plurality of cam plates, a plurality of nozzles, and a plurality of rollers. The case is adapted to mount to a gas turbine engine. The afterburner nozzle actuators are coupled to the case and are configured to selectively supply an actuation force. The actuation structure surrounds at least a portion of the case and includes a forward end, an aft end, an inner surface, and an outer surface. The aft end has a polygonal cross section shape. The actuation structure is coupled to receive the actuation force supplied from the afterburner nozzle actuators and is configured, upon receipt of the actuation force, to translate relative to the case in either an open direction or a closed direction. The cam plates are removably coupled to the inner surface of the actuation structure, and each includes a cam surface. The nozzle flaps are rotationally coupled to the case and extend at least partially from the actuation structure aft end. Each nozzle flap is movably coupled to a different one of the cam plates. The rollers are each rotationally mounted on a different one of the nozzle flaps and engage the cam surface of one of the cam plates.

Furthermore, other desirable features and characteristics of the disclosed embodiments will become apparent from the subsequent detailed description and the appended claims, taken in conjunction with the accompanying drawings and this background preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of an exemplary gas turbine engine control system;

FIGS. 2 and 3 depict an embodiment of an afterburner nozzle actuation system in an open and a closed position, respectively, and that may be used in the system of FIG. 1;

FIG. 4 depicts a side-view of the afterburner nozzle actuation system in its open position;

FIG. 5 depicts a close-up isometric view of a portion of the afterburner nozzle actuation system, illustrating nozzle flaps, nozzle seals, and various other hardware in more detail;

FIG. 6 depicts a close-up cross section view of a portion of the afterburner nozzle actuation system, taken along line 6-6 in FIG. 2;

FIGS. 7 and 8 depict close-up cross section views, similar to the one depicted in FIG. 6, with the afterburner nozzle actuation system in the open and closed positions, respectively; and

FIG. 9 depicts an end view of the afterburner nozzle actuation system.

### DETAILED DESCRIPTION

The following detailed description is merely exemplary in nature and is not intended to be limiting. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

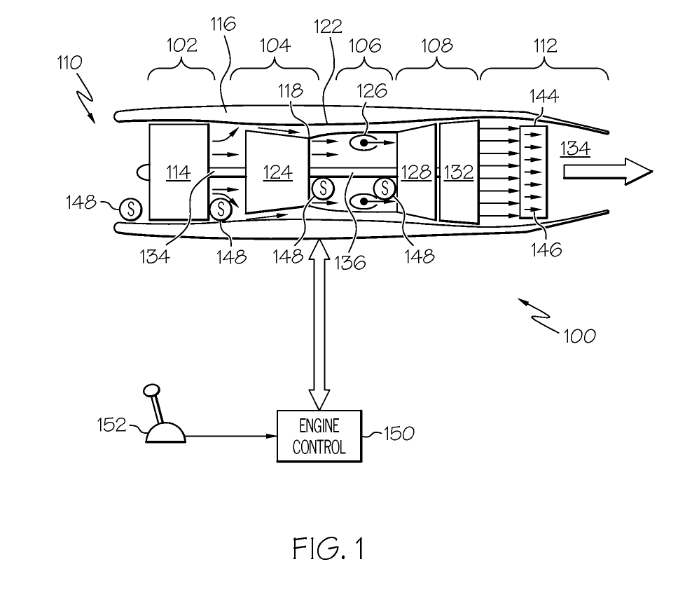

Turning now to FIG. 1, a functional block diagram of an exemplary gas turbine engine control system 100 is depicted. The depicted engine control system 100 includes a gas turbine engine 110 and an engine control 150. The gas turbine engine 110, at least in the depicted embodiment, is a multi-spool turbofan gas turbine engine, and includes an intake section 102, a compressor section 104, a combustion section 106, a propulsion turbine 108, and an exhaust section 112. The intake section 102 includes a fan 114, which is mounted in a fan case 116. The fan 114 draws air into the intake section 102 and accelerates it. A fraction of the accelerated air exhausted from the fan 114 is directed through a bypass section 118 disposed between the fan case 116 and an engine cowl 122, and provides a forward thrust. The remaining fraction of air exhausted from the fan 114 is directed into the compressor section 104.

The compressor section 104 may include one or more compressors 124, which raise the pressure of the air directed into it from the fan 114, and directs the compressed air into the combustion section 106. In the depicted embodiment, only a single compressor 124 is shown, though it will be appreciated that one or more additional compressors could be used. In the combustion section 106, which includes a combustor assembly 126, the compressed air is mixed with fuel supplied from a non-illustrated fuel source. The fuel and air mixture is combusted, and the high energy combusted air mixture is then directed into the propulsion turbine 108.

The propulsion turbine 108 includes one or more turbines. In the depicted embodiment, the propulsion turbine 108 includes two turbines, a high pressure turbine 128, and a low pressure turbine 132. However, it will be appreciated that the propulsion turbine 108 could be implemented with more or less than this number of turbines. No matter the particular number, the combusted air mixture from the combustion section 106 expands through each turbine 128, 132, causing it to rotate. The combusted air mixture is then exhausted through a variable geometry nozzle 134 disposed in the exhaust section 112, providing additional forward thrust. As the turbines 128 and 132 rotate, each drives equipment in the engine 100 via concentrically disposed shafts or spools. Specifically, the high pressure turbine 128 drives the compressor 124 via a high pressure spool 136, and the low pressure turbine 132 drives the fan 114 via a low pressure spool 138.

As FIG. 1 further depicts, an afterburner 144 is disposed downstream of the propulsion turbine 108 and upstream of the variable geometry nozzle 134, and includes a plurality of fuel injectors 146. When the afterburner 144 is activated, fuel from the above-mentioned non-illustrated fuel source is supplied to the fuel injectors 146. The fuel discharged from the fuel injectors 146 is mixed with the bypass air and the combusted air mixture that is discharged from the propulsion turbine 108, via the variable geometry nozzle 134. The heat of the combusted air mixture combusts the fuel, which generates additional thrust, on top of the thrust generated by the propulsion turbine 108 bypass air.

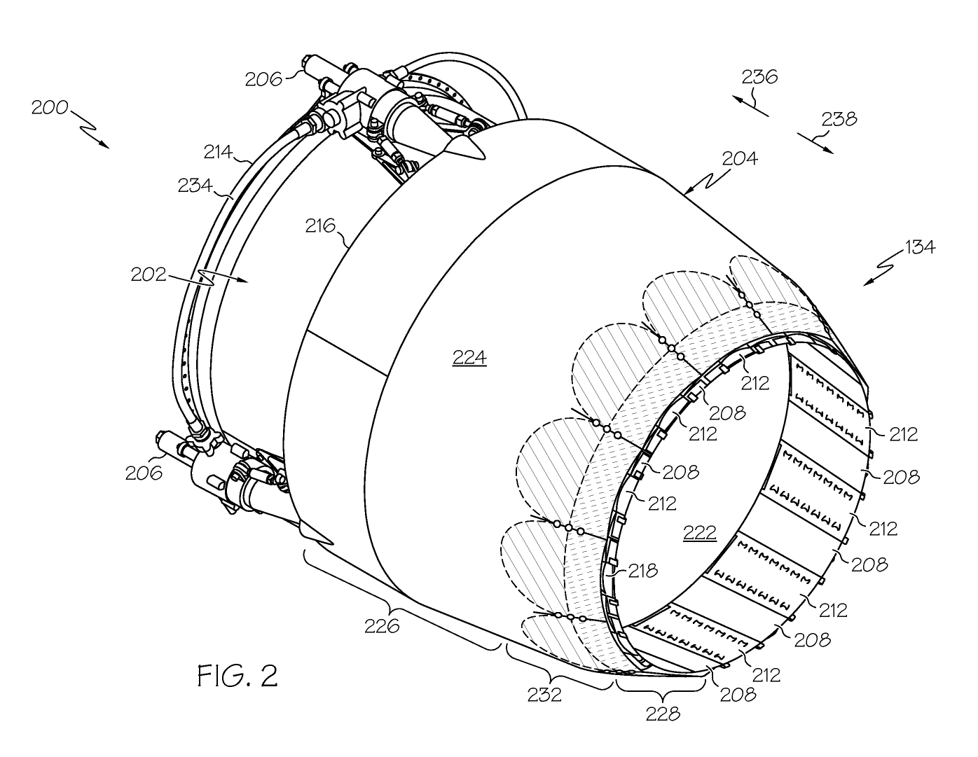

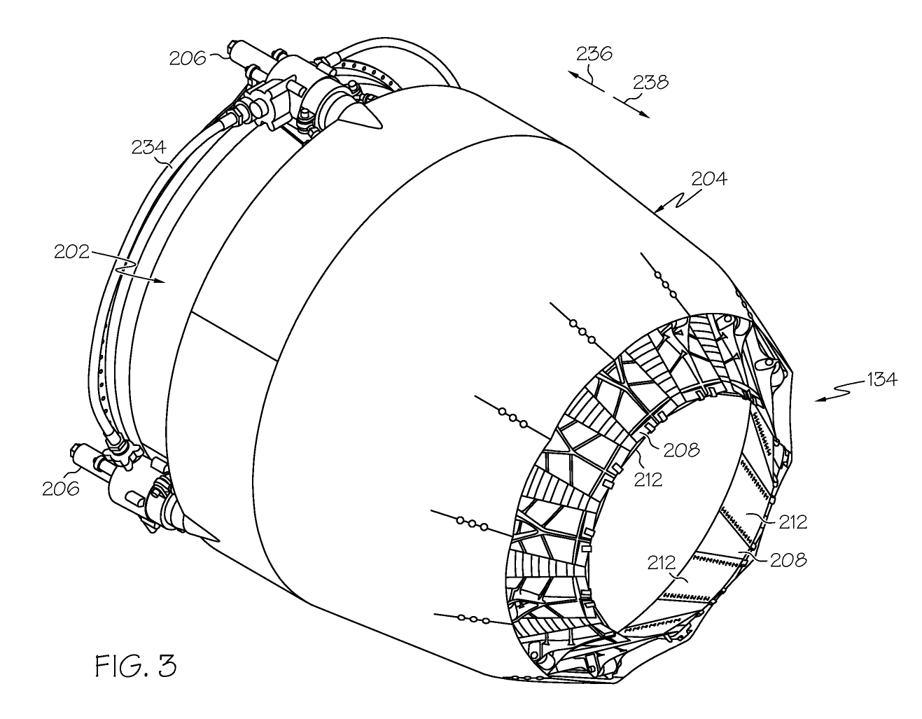

The variable geometry nozzle 134, as this nomenclature connotes, provides a cross sectional flow area, through which exhaust and bypass air flow, which is variable in cross section. The flow area of the variable geometry exhaust nozzle 134 is controlled via an afterburner nozzle actuation system. An embodiment of the afterburner nozzle actuation system is depicted in FIGS. 2 and 3, and with reference thereto will now be described.

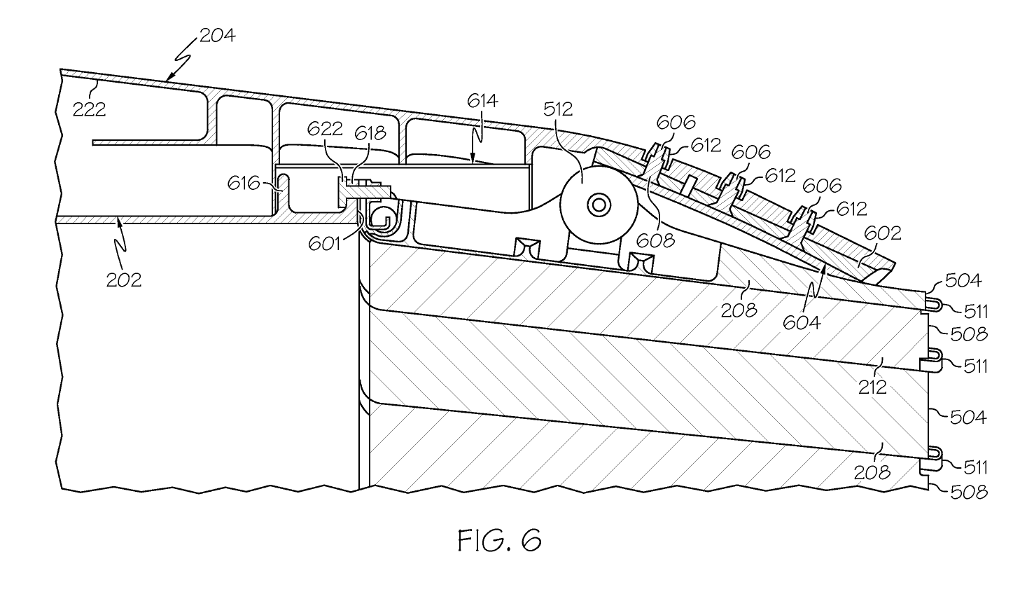

The depicted afterburner nozzle actuation system 200 includes a case 202, an actuation structure 204, a plurality of afterburner nozzle actuators 206, a plurality of nozzle flaps 208, and a plurality of seal flaps 212. The case 202 is mounted to the gas turbine engine 110, and more particularly to the engine cowl 122 (see FIG. 1). The case 202 may be variously shaped and configured, and may be mounted to the gas turbine engine 110 using any one of numerous techniques. The depicted case 202 is generally circular in cross section, with a diameter that decreases from its forward end 214 to its aft end 601 (see FIG. 6) to form a semi-conical nozzle shape. It will be appreciated, however, that the case 202 may alternatively be cylindrical in shape, and that it may also be formed to have various other, non-circular cross sections. The depicted case 202 is also mounted to the gas turbine engine 110 at its forward end 214 via a plurality of non-depicted fasteners.

The actuation structure 204 surrounds at least a portion of the case and includes a forward end 216, an aft end 218, an inner surface 222, and an outer surface 224. The actuation structure 204 is configured such that the forward end 216, at least in the depicted embodiment, has a circular cross section shape, and the aft end 218 has a polygonal cross section shape. It will be appreciated that the forward end 216 may also be formed to have various other, non-circular cross sections, if needed or desired for installation. The actuation structure 204 is additionally configured to transition from the circular cross section shape at the forward end 216 to the polygonal cross section shape at the aft end 218 using a continuous variation is surface curvature. In this regard, the actuation structure 204 is additionally defined to include a forward section 226, an aft section 228, and a transition section 232.

The forward section 226 extends from the forward end 216 toward the transition section 232, and has a circular cross section shape, that decreases in diameter, throughout its axial length. The aft section 228, which is illustrated in FIG. 2 with dashed cross hatching lines for clarity, extends from the transition section 232 to the aft end 218, and has an uninterrupted polygonal cross section shape throughout its axial length. As shown most clearly in FIG. 9, the polygonal cross section of the depicted aft section 228 has twelve sides. It will nonetheless be appreciated that this number may vary, as needed or desired. The transition section 232, which is illustrated in FIG. 2 with solid cross hatching lines for clarity, is disposed between the forward section 226 and the aft section 228. The transition section 232 has cross sectional shape that provides the transition from the circular cross section shape of the forward section 226 to the polygonal cross section shape of the aft section 228.

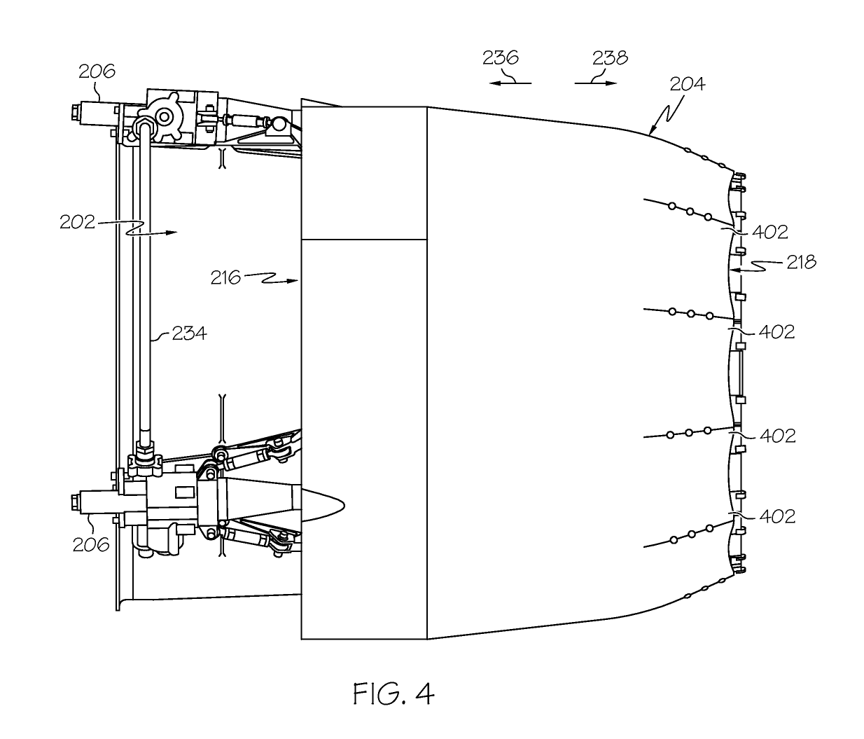

The actuation structure 204 is preferably, though not necessarily, formed of a single, unitary casting. The structural material that comprises the actuation structure may vary, but in a particular embodiment the actuation structure is formed of titanium (Ti). No matter the particular material, and with reference to FIG. 9, the actuation structure 204 supports radial loads from the nozzle flaps 208 (depicted using the arrows extending radially outwardly) at the corners 902 of the uninterrupted polygonal cross section by tensile hoop stress (depicted using the double-headed arrows) due to the polygonal shape of the aft section 228. Moreover, as shown most clearly in FIG. 4, the aft end 218 of the actuation structure 204 may additionally be configured to include a plurality of chevron shaped structural features 402. These structural features 402, if included, reduce the overall weight and drag of the actuation structure 204.

The afterburner nozzle actuators 206 are coupled to the case 202, and are each configured to selectively supply an actuation force to the actuation structure 204. The number and type of actuators that are used to implement each of the afterburner nozzle actuators 206 may vary. In the depicted embodiment, the afterburner nozzle actuation system 200 is implemented with three mechanical afterburner nozzle actuators 206 (only 2 visible). As FIGS. 2 and 3 further illustrate, the afterburner nozzle actuators 206 are interconnected via a plurality of drive mechanisms 234, each of which, at least in the particular depicted embodiment, is a flexible shaft. Using flexible shafts 234 in this configuration ensures that the afterburner nozzle actuators 206 move the actuation structure 204 in a substantially synchronized manner. Other synchronization mechanisms that may be used, and include electrical synchronization or open loop synchronization, or any other mechanism or design that transfers power between the actuators 206.

No matter the number and type of afterburner nozzle actuators 206, the actuation structure 204 is coupled to receive the actuation force supplied from each afterburner nozzle actuator 206. The actuation structure 204, upon receipt of the actuation force, translates relative to the case 202 in either an open direction 238 or a closed direction 236, to thereby place the variable geometry nozzle 134 in its open position or its closed position. In the open position, which is the position depicted in FIGS. 2 and 4, the nozzle flaps 208 and seal flaps 212 are almost fully retracted into the actuation structure 204. Conversely, in the closed position, which is the position depicted in FIG. 3, the nozzle flaps 208 and seal flaps 212 extend from the actuation structure 204, and more specifically from the aft end 218 of the actuation structure 204. Thus, as may be readily appreciated, the cross sectional flow area of the variable geometry nozzle 134 is reduced when it is in the closed position.

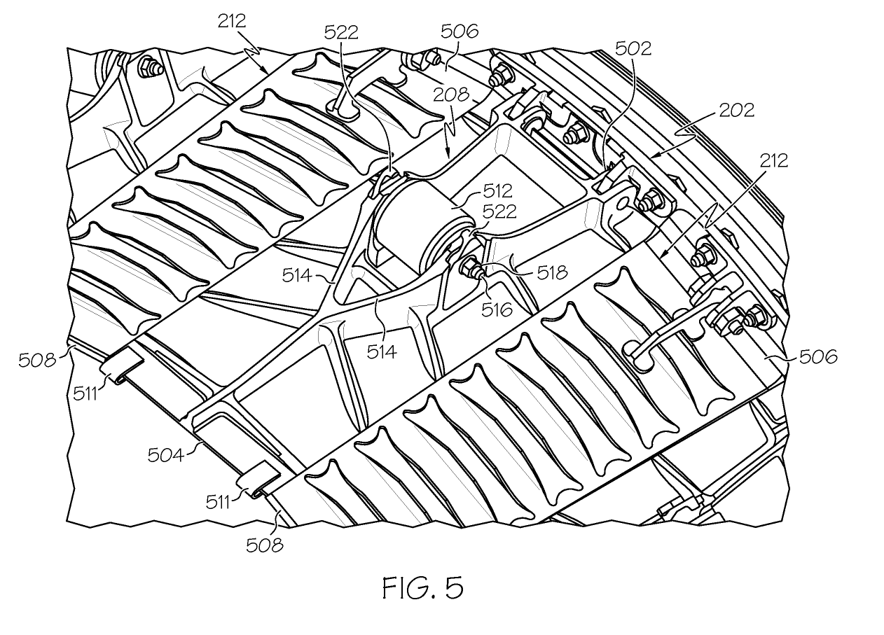

The above-described movement of the nozzle flaps 208 and seal flaps 212, in response to the translation of the actuation structure 204, is facilitated by the interplay of various additional structural features that are associated with the actuation structure 204, the nozzle flaps 208, and the seal flaps 212, but which are not visible in FIGS. 2-4. These additional structural features are shown more clearly in FIGS. 5 and 6, and with reference thereto will now be described in more detail.

Referring first to FIG. 5, it is seen that each nozzle flap 208 includes a leading edge 502 and a trailing edge 504, and that each seal flap 212 also includes a leading edge 506 and a trailing edge 508. Each nozzle flap 208 is rotationally coupled to the case 202 proximate its leading edge 502 and each seal flap 212, which is disposed between two nozzle flaps 208, is also rotationally coupled to the case 202 via its leading edge 506. As FIG. 6 more clearly depicts, the trailing edge 504, 508 of each nozzle flap 208 and each seal flap 212 extends at least partially from the actuation structure aft end 218.

Returning to FIG. 5, it is seen that a plurality of clips 511 are coupled to each one of the seal flaps 212, proximate its trailing edge 508. Each of the clips 511 extends around the trailing edge 504 of the nozzle flap 208 on either side of the associated seal flap 212. The clips 511 slidingly engage the associated nozzle flaps 208 so that trailing edges 508 the seal flaps 212 may move relative to the trailing edges 504 of the associated nozzle flaps 208. For example, as may be readily seen with reference back to FIGS. 2 and 3, a larger portion of the trailing edges 508 of the seal flaps 212 will be disposed under the associated nozzle flaps 208 when the variable geometry nozzle 134 is in the closed position, as compared to when the variable geometry nozzle 134 is in the open position. As may be appreciated, the clips 511 also maintain the relative positioning of the seal flaps 212 when the gas turbine engine 110 is not running.

Returning again to FIG. 5, a roller 512 is rotationally mounted on each of the nozzle flaps 208. Each roller 512 is rotationally mounted via mounting features 514 that are formed on each nozzle flap 208, and via suitable mounting hardware such as, for example, a threaded bolt 516, nuts 518 (only one visible), and a non-visible spacer sleeve. As FIG. 5 also depicts, each of the rollers 512 is coupled to, and is rotatable relative to, a pair of cam plate engagement features 522. Although these may be variously implemented and configured, the depicted cam plate engagement features 522 are each implemented as inwardly extending tangs, the purpose of which will be described more fully below.

Referring once again to FIG. 6, a plurality of cam plates 602 are coupled to the inner surface 222 of the actuation structure 204. Each cam plate 602 includes a cam surface 604 that is engaged by each of the rollers 512. Each cam plate 602 is also slidingly engaged by each of the cam plate engagement features 522 (not shown in FIG. 6). Thus, the cam plate engagement features 522 maintain the relative positioning of the nozzle flaps 208 when the gas turbine engine 110 is not running. Although the manner in which the cam plates 602 may be coupled to the actuation structure 204 may vary, in the depicted embodiment, each cam plate 602 is removably coupled to the inner surface 222 of the actuation structure 204 via a plurality of cam bolts 606. This allows for relatively easy repair, and the ability to change the actuation profile. Although three cam bolts 606 per cam plate 602 are depicted in FIG. 6, it will be appreciated that more or less than this number of cam bolts 606 may be used. The cam bolts 606 preferably include a bolt head 608 that is ground, or otherwise configured, to be flush with the cam surface 604. Each cam bolt 606 is threaded into a nut 612 that is counterbored into the outer surface 224 of the actuation structure 204.

In addition to the above, and with continued reference to FIG. 6, the case 202 and the actuation structure 204 include additional features that are used to center the actuation structure 204 and control airflow. Specifically, it is seen that the inner surface 222 of the actuation structure 204 is configured to include a cylindrical section 614, and the case 202 is configured to include a pair of spaced apart flanges—a first flange 616 and a second flange 618—disposed proximate its aft end 601. The cylindrical section 614 has an axial length approximately equal to the movement length of the actuation structure 204 and, together with the first flange 616, defines a controlled gap to center the actuation structure 204.

The first flange 616 and the second flange 618 extend radially outwardly from the case 202 to a height. The first flange 616 extends to a height that is greater than that of the second flange 618, and is preferably configured to control the airflow passing between the case 202 and actuation structure 204. The second flange 618 includes openings through which fastener hardware 622 extend to mount the nozzle flaps 208 and seal flaps 212.

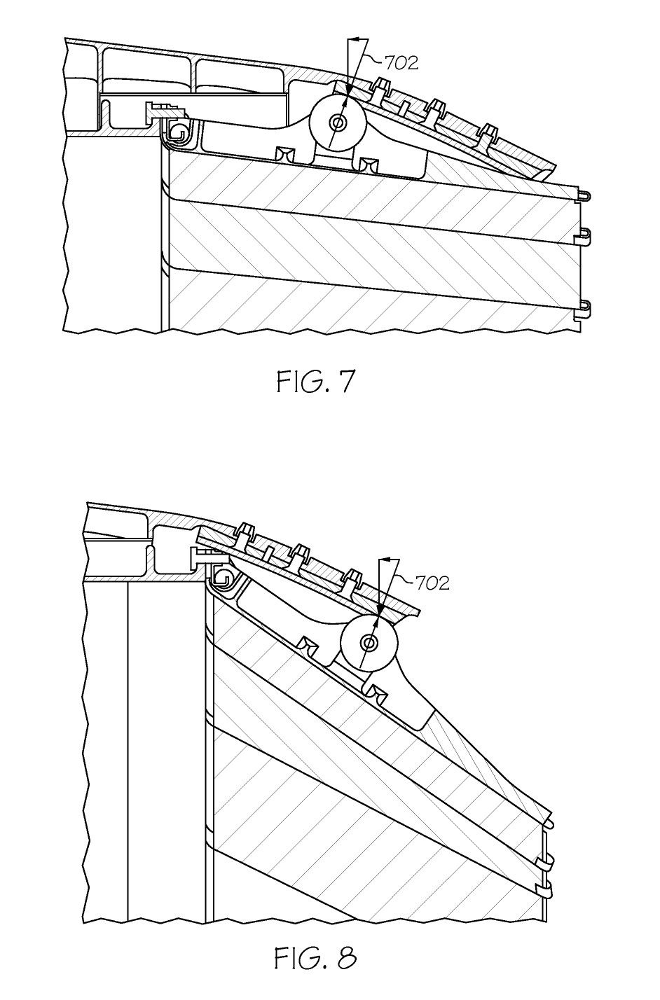

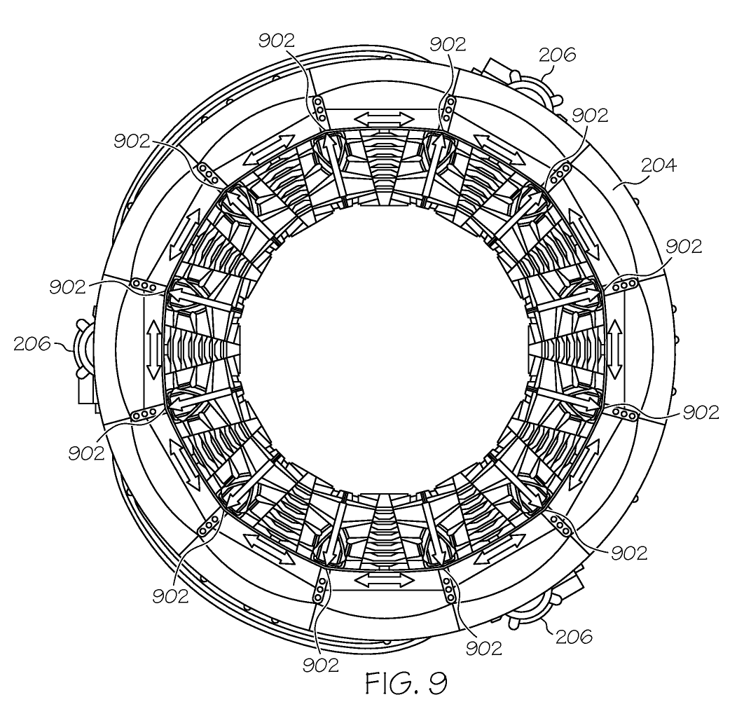

The configuration of the afterburner nozzle actuation system 200 provides several benefits over presently known systems. One benefit is that the loads on the afterburner nozzle actuators 206 are reduced. In particular, because the cam surfaces 604 are disposed on the inner surface 222 of the actuation structure 204, and the rollers 512 are disposed on the nozzle flaps 208, the roller-to-cam contact geometry may be controlled to reduce the actuator load. This is illustrated in FIGS. 7 and 8, which depict the roller-to-cam contact normal direction, in the open and closed positions, respectively. As depicted, the roller-to-cam contact normal direction 702 (and also the moment arm length) is nearly constant during actuation between these positions, which leads to lower maximum axial and radial loads.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An afterburner nozzle actuation system, comprising:
a case adapted to mount to a gas turbine engine;
an actuation structure surrounding at least a portion of the case and including a forward end, an aft end, an inner surface, and an outer surface, the aft end having a polygonal cross section shape, the actuation structure adapted to receive an actuation force from an afterburner nozzle actuator and configured, upon receipt of the actuation force, to translate relative to the case in either an open direction or a closed direction;
a plurality of cam plates removably coupled to the inner surface of the actuation structure, each of the cam plates including a cam surface;
a plurality of nozzle flaps rotationally coupled to the case and extending at least partially from the actuation structure aft end, each nozzle flap movably coupled to a different one of the cam plates; and
a plurality of rollers, each roller rotationally mounted on a different one of the nozzle flaps and engaging the cam surface of one of the cam plates.

2. The system of claim 1, wherein the aft end comprises a plurality of chevron shaped structural features.

3. The system of claim 1, wherein the actuation structure is formed of a single, unitary metal casting.

4. The system of claim 1, wherein:
the actuation structure includes a forward section, an aft section, and a transition section between the forward section and the aft section;
the forward section has a circular cross section shape;
the aft section has a polygonal cross section shape; and
the transition section has cross section that transitions from the circular cross section shape to the polygonal cross section shape using a continuous variation in surface curvature.

5. The system of claim 1, further comprising:
a plurality of cam plate engagement features coupled to, and extending from, each of the nozzle flaps, each cam plate engagement feature including a tang that slidingly engages one of the cam plates.

6. The system of claim 5, wherein each of the rollers is coupled to, and rotatable relative to, two cam plate engagement features.

7. The system of claim 1, further comprising:
a plurality of seal flaps rotationally coupled to the case, each seal flap disposed between two nozzle flaps.

8. The system of claim 7, wherein:
each nozzle flap includes a leading edge and a trailing edge, and is rotationally coupled to the case proximate its leading edge;
each seal flap includes a leading edge and a trailing edge, and is rotationally coupled to the case proximate its leading edge.

9. The system of claim 8, further comprising:
a plurality of clips, each clip coupled to a different one of the seal flaps proximate the trailing edge of the seal flap, and extending around the trailing edge of one of the nozzle flaps.

10. The system of claim 1, further comprising:
a plurality of cam bolts, wherein each cam plate is removably coupled to the inner surface of the actuation structure via at least one of the cam bolts.

11. An afterburner nozzle actuation system, comprising:
a case adapted to mount to a gas turbine engine;
a plurality of afterburner nozzle actuators coupled to the case, each afterburner nozzle actuator configured to selectively supply an actuation force;
an actuation structure surrounding at least a portion of the case and including a forward end, an aft end, an inner surface, and an outer surface, the aft end having a polygonal cross section shape, the actuation structure coupled to receive the actuation force supplied from each afterburner nozzle actuator and configured, upon receipt thereof, to translate relative to the case in either an open direction or a closed direction;
a plurality of cam plates removably coupled to the inner surface of the actuation structure, each of the cam plates including a cam surface;
a plurality of nozzle flaps rotationally coupled to the case and extending at least partially from the actuation structure aft end, each nozzle flap movably coupled to a different one of the cam plates; and
a plurality of rollers, each roller rotationally mounted on a different one of the nozzle flaps and engaging the cam surface of one of the cam plates.

12. The system of claim 11, wherein the aft end comprises a plurality of chevron shaped structural features.

13. The system of claim 11, wherein the actuation structure is formed of a single, unitary metal casting.

14. The system of claim 11, wherein:
the actuation structure includes a forward section, an aft section, and a transition section between the forward section and the aft section;
the forward section has a circular cross section shape;
the aft section has a polygonal cross section shape; and
the transition section has cross section that transitions from the circular cross section shape to the polygonal cross section shape using a continuous variation in surface curvature.

15. The system of claim 11, further comprising:
a plurality of cam plate engagement features coupled to, and extending from, each of the nozzle flaps, each cam plate engagement feature including a tang that slidingly engages one of the cam plates.

16. The system of claim 15, wherein each of the rollers is coupled to, and rotatable relative to, two cam plate engagement features.

17. The system of claim 11, further comprising:
a plurality of seal flaps rotationally coupled to the case, each seal flap disposed between two nozzle flaps.

18. The system of claim 17, wherein:
each nozzle flap includes a leading edge and a trailing edge, and is rotationally coupled to the case proximate its leading edge;
each seal flap includes a leading edge and a trailing edge, and is rotationally coupled to the case proximate its leading edge.

19. The system of claim 18, further comprising:
a plurality of clips, each clip coupled to a different one of the seal flaps proximate the trailing edge of the seal flap, and extending around the trailing edge of one of the nozzle flaps.

20. The system of claim 11, further comprising:
a plurality of cam bolts, wherein each cam plate is removably coupled to the inner surface of the actuation structure via at least one of the cam bolts.
